(19) United States
(12) Patent Application Publication
(10) Pub. No.: US 2006/0080473 A1
(43) Pub. Date: Apr. 13, 2006

(54) Apparatus for emulating memory and method thereof

(76) Inventors: Jing-Rung Wang, Hsin-Tien City (TW); Chia-Hsing Yu, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/078,428

(22) Filed: Mar. 14, 2005

(30) Foreign Application Priority Data
Oct. 8, 2004 (TW) 093130558

(51) Int. Cl. G06F 3/00

(52) U.S. Cl. 710/7

(57) ABSTRACT

A memory emulating apparatus and its method are proposed to emulate a read-only memory (ROM) of a motherboard. The motherboard has a first or a second ROM socket. The present invention includes a first and second connectors for connecting with the first and the second ROM socket respectively, a rewritable memory for storing a system code and a controller connected with the first and second connectors and the rewritable memory. If the first connector is connected to the first ROM socket, the controller enters a first access mode to access the system code and passes it to the first ROM socket via the first connector. Otherwise, if the second connector is connected to the second ROM socket, the controller enters a second access mode to access the system code and passes it to the second ROM socket via the second connector for the motherboard to check.

### BACKGROUND OF THE INVENTION

1. Field of the Invention

The present invention is related to an apparatus for emulating a memory and its method, and more particularly, to a memory emulating apparatus that is adaptive for various read-only memory (ROM) sockets with different transmission interface standards and a method for the same.

2. Description of Related Art

In general, a read-only memory (ROM) having a basic input/output system (BIOS), i.e. system code, stored therein is directly plugged into a ROM socket of a motherboard for computer booting. In the early days, a developer needs to repeatedly modify BIOS codes and record them into ROMs. Subsequently, he needs to plug the ROM with BIOS codes into a corresponding socket of a motherboard for testing. That is very time-consuming and inconvenient. Hence, ROM emulators were developed to emulate the ROM of the motherboard. By using ROM emulators in BIOS code developing process, the developer can modify BIOS codes at any time. In the present, most of ROMs of motherboards employ industry standard architecture (ISA) interfaces for data transmission. Hence, all of the ROM emulators used nowadays are ISA ROM emulators.

Reference is made to FIG. 1, which is a block diagram of a conventional memory emulator. As shown in the figure, it has an ISA ROM emulator 10, which has one end connected with a personal computer (PC) 11 and another end connected to an ISA ROM socket 14 of a motherboard 13 via an ISA ROM adaptor 12. Thus, the developer can uses the PC 11 to load a developed or modified BIOS code into a random access memory (RAM) of the ISA ROM emulator 10 (the RAM is not shown in the figure), wherein the RAM is compatible with the transmission interface of the ISA ROM socket 14. Then, the motherboard 13 can read the BIOS code stored in the RAM via the ISA ROM socket 14 and ISA ROM adaptor 12 and executes the BIOS code. Thus, the developer can develop and modify the BIOS code step by step according to the execution results of the motherboard 13.

Moreover, formerly in order to connect with an ISA expansion slot/interface card and BIOS ROM or control an input/output (I/O) interface such as 2S1P1G, a south bridge chip needs to preserve an ISA bus and connect with a Super I/O chip so as to control conventional peripherals. However, the ISA bus has electrical features and definition of signals greatly different to that of a conventional peripheral component interconnect (PCI) bus. That makes the south bridge chip or Super I/O chip have to use more pins for signal transmission and makes the designs for clock/lines of motherboards become complicated.

Therefore, a transmission interface structure, called low pin count (LPC) transmission interface, was developed to replace the conventional ISA transmission interface. Hence, ISA read-only memory socket (it has 30 pins) is gradually replaced by LPC read-only memory socket (it only has 7 pins). Since the number of pins for LPC transmission interface is much smaller than that of ISA transmission interface, using LPC transmission interface for chip design relatively reduces the number of pins, volume and cost of the Super I/O chip or Flash chip and simplifies the structure of motherboards. Hence, LPC transmission interface is gradually used in the motherboards.

However, conventional ISA ROM emulators are only adaptive to the motherboard with ISA ROM sockets. In other words, the conventional ISA ROM emulators cannot be used together with the LPC ROM sockets. Hence, in order to solve this problem, the present invention provides a memory emulating apparatus and its method that can be used together with various ROM sockets with different transmission interface standards.

### SUMMARY OF THE INVENTION

An objective of the present invention is to provide an apparatus for emulating a memory and its method. Therein, by converting the signal formats, the present invention is adaptive to be used together with the ROM sockets with different interface standards. Hence, the present invention is convenient in usage. Another objective of the present invention is to provide an apparatus for emulating a memory and its method, which intercept the post/debug code produced when the motherboard executes the system code and performs a Power On Self Test (POST) process and show the test result on a displayer.

Still another objective of the present invention is to provide an apparatus for emulating a memory and its method, which uses a high-speed connector to connect with a computer so that the computer can load the system code to the memory emulating apparatus in a high speed.

For achieving the objectives above, the present invention provides a memory emulating apparatus and its method, which are used to emulate a read-only memory (ROM) of a motherboard. The motherboard has a first ROM socket or a second ROM socket disposed thereon. Therein, the first ROM socket is an ISA ROM socket and the second ROM socket is a LPC ROM socket. The present invention includes a first connector, a second connector, a rewritable memory and a controller. The first connector is used for connecting with the first ROM socket. The second connector is used for connecting with the second ROM socket. The rewritable memory is used to store a system code. The controller is connected with the first connector, the second connector and the rewritable memory. When the first connector is connected to the first ROM socket and the motherboard is activated, the controller enters a first access mode to access the system code and passes the system code to the first ROM socket via the first connector for the motherboard to check. Otherwise, when the second connector is connected to the second ROM socket and the motherboard is activated, the controller enters a second access mode to access the system code and passes the system code to the second ROM socket via the second connector for the motherboard to check.

Numerous additional features, benefits and details of the present invention are described in the detailed description, which follows.

### BRIEF DESCRIPTION OF THE DRAWINGS The foregoing aspects and many of the attendant advantages of this invention will be more readily appreciated as the same becomes better understood by reference to the following detailed description, when taken in conjunction with the accompanying drawings, wherein:

FIG. 1 is a block diagram of a conventional memory emulating apparatus; and

FIG. 2 is a block diagram of a preferred embodiment in accordance with the present invention.

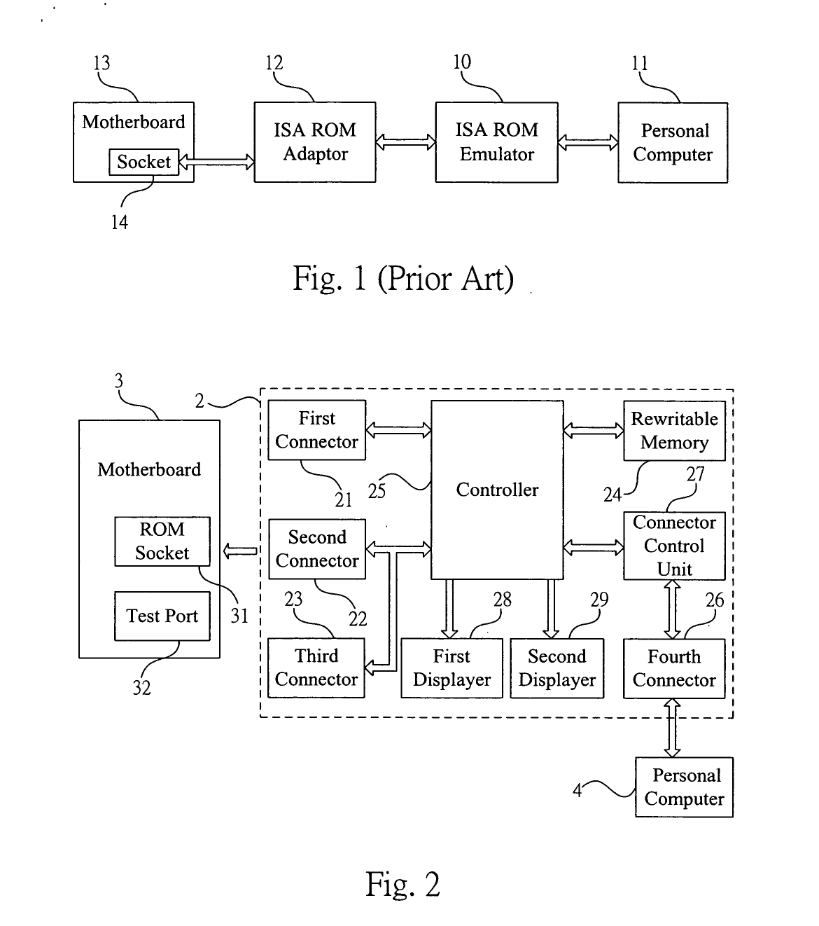

### DETAILED DESCRIPTION OF PREFERRED EMBODIMENTS

Reference is made to FIG. 2, which is a block diagram of a preferred embodiment in accordance with the present invention. As shown in the figure, the memory emulating apparatus 2 of the present invention is connected to a motherboard 3 for emulating a ROM. In general, the ROM is plugged in a ROM socket 31 of the motherboard 3. According to the ROM standard supported by the motherboard 3, the ROM socket 31 can be a conventional ISA ROM socket or LPC ROM socket. In the present invention, for convenience of connecting the memory emulating apparatus 2 to the motherboard 3, the motherboard 3 has a test port 32, which is a LPC male port. The memory emulating apparatus 2 of the present invention mainly has a first connector 21, a second connector 22, a third connector 23, a rewritable memory 24 and a controller 25.

The first connector 21 is an ISA ROM connector, the second connector 22 is a LPC ROM connector and the third connector 23 is a LPC female port. Both of the first connector 21 and the second connector 22 are used to connect with the ROM socket 31 of the motherboard 3. Namely, if the ROM socket 31 is an ISA ROM socket, the first connector 21 is used to connect with the ROM socket 31. Otherwise, if the ROM socket 31 is a LPC ROM socket, using the second connector 22 to connect with the ROM socket 31. The third connector 23 is used to connect with the test port 32.

In this embodiment, the rewritable memory 24 is an asynchronous static random access memory (ASYNC SRAM) for storing a BIOS code. Its electrical features and definition of signals are compatible with the ISA ROM socket. Of course the rewritable memory 24 can also be other memories compatible with the ISA ROM socket, such as Flash memory.

In this embodiment, the controller 25 is a LPC/ISA controller, which is connected with the first connector 21, the second connector 22, the third connector 23 and the rewritable memory 24. It is used to access the BIOS code from the rewritable memory 24 and pass the accessed BIOS code to the first connector 21, the second connector 22, the third connector 23. The controller 25 can be an application integrated circuit (ASIC) or complex programmable logic device (CPLD). In addition, for loading the BIOS code from the personal computer (PC) 4 to the rewritable memory 24, the memory emulating apparatus 2 further includes a fourth connector 26 and a connector control unit 27. In this embodiment, the fourth connector 26 is a universal serial bus (USB) port and the connector control unit 27 is a USB+8051 controller. The connector control unit 27 is connected with the fourth connector 26 and the controller 25. The connector control unit 27 is used to control the fourth connector 26 to receive the BIOS code sent from the PC 4 and store the BIOS code in the rewritable memory 24. By using the USB port, the PC 4 can store the BIOS code in the rewritable memory 24 of the memory emulating apparatus 2 with a faster transmission speed for saving time.

Thus, if the ROM socket 31 of the motherboard 3 is an ISA ROM socket, the first connector 21 of the memory emulating apparatus 2 is used to connect with the ROM socket 31. Since both of the rewritable memory 24 and the ISA ROM socket use parallel-type signals with a compatible clock, the controller 25 enters a first access mode to access the rewritable memory 24, namely, directly access the BIOS code from the rewritable memory 24. Then, the controller 25 passes the BIOS code to the ROM socket 31 via the first connector 21 for the motherboard 3 to execute the BIOS code. Furthermore, the controller 25 will adjust the voltage level of the control signal sent from the ROM socket 31 (from +5V to +3.3V). Similarly, the voltage level of the signals of the BIOS code accessed from the rewritable memory 24 also needs to be adjusted (from +3.3V to +5V). Besides, the controller 25 can also temporarily store the control signals and the signals of the BIOS code sent from the PC 4 to prevent collision.

If the ROM socket 31 of the motherboard 3 is a LPC ROM socket, the second connector 22 of the memory emulating apparatus 2 is used to connect with the ROM socket 31. However, the definition of the signals and clock for the rewritable memory 24 is different to that for the LPC ROM socket. The LPC interface uses serial-type signals. In this case, the controller 25 enters a second mode to access the rewritable memory 24. Namely, the controller 25 converts the LPC signals sent from the ROM socket 31 to ISA signals. It means that it converts serial signals to parallel signals and convert the clock from 33 MHz to 8 MHz to fit in with the interface standard of the rewritable memory 24. Furthermore, the controller 25 converts the ISA signals of the BIOS code accessed from the rewritable memory 24 to LPC signals and converts the clock from 8 MHz to 32 MHz to fit in with the interface standard of the ROM socket 31. Thereby, the controller 25 can pass the BIOS code to the ROM socket 31 via the second connector 22 for the motherboard 3 to check.

Similarly, if the third connector 23 is used to connect with the test port 32 of the motherboard 3, the controller 25 enters the second mode to access the rewritable memory 24. Namely, the controller 25 converts the LPC signals sent from the test port 32 to ISA signals to fit in with the interface standard of the rewritable memory 24. Furthermore, the controller 25 converts the ISA signals of the BIOS code accessed from the rewritable memory 24 to LPC signals to fit in with the interface standard of the test port 32. Thereby, the controller 25 can pass the BIOS code to the test port 32 via the third connector 23 for the motherboard 3 to check.

Therefore, as the description above, the memory emulating apparatus 2 can connect with various ROM sockets with different transmission interface standards via the first connector 21, the second connector 22 or the third connector 23. It also employs the controller 24 to performs interface conversion for the ROM socket 31, the test port 32 and the rewritable memory 25 to make the BIOS code stored in the rewritable memory 25 able to be accessed via the ROM socket 31 or the test port 32.

In addition, the memory emulating apparatus 2 further includes a first displayer 28 and a second displayer 29. In the embodiment, the first displayer 28 and the second displayer 29 are seven segment displayers connected to the controller 25. When the motherboard 3 executes the BIOS code and performs a Power On Self Test (POST) process, the post/debug code produced in the test process will be delivered to the I/O port 80h and/or 84h. In the embodiment, the controller 25 will intercept this post/debug code and decode it so as to show the test result on the first displayer 28 and the second displayer 29. Thereby, the present invention can achieve the functions of conventional Debug cards (or POST cards) so that the present invention doesn't need to use these cards and can directly replace them.

Most of the conventional Debug cards need to be externally plugged into the motherboard 3 for connection. In the present, a high-speed transmission standard, called PCI-Express standard, has been proposed as a transmission interface standard for external connection. However, this kind of transmission interface standard defines a signal transmission format that makes the conventional Debug cards unable to intercept the post/debug code and causes a problem of code testing. As described above, since using the present invention to test the BIOS codes can directly obtain the test result by decoding the post/debug code, the developer can modify the BIOS code according to the obtained test result without using the externally plugged Debug card. Hence, the present invention is very convenient for the device developer.

In accordance with the description above, the memory emulating apparatus 2 of the present invention is capable of connecting with the ROM socket 31 or test port 32 complied with various interface standards via the first connector 21, the second connector 22 or the third connector 23. Besides, by using the controller 25, the present invention can perform interface conversion for the rewritable memory 24, the ROM socket 31 and the test port 32. Thereby, the motherboard 3 can access the rewritable memory 24 via the ROM socket 31 and the test port 32. Hence, the memory emulating apparatus 2 of the present invention is adaptive to be used together with the ROM socket 31 or test port 32 complied with various interface standards. In addition, during the POST process of the BIOS code, the controller 25 can intercept the post/debug code produced in the POST process and then decode it so as to show the test result on the first displayer 28 and the second displayer 29. Hence, the present invention can achieve the functions of conventional Debug cards (or POST cards).

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A memory emulating apparatus, used to emulate a read-only memory (ROM) of a motherboard, the motherboard having a first ROM socket or a second ROM socket disposed thereon, the memory emulating apparatus comprising:
a first connector for connecting with the first ROM socket;
a second connector for connecting with the second ROM socket;
a rewritable memory having a system code stored therein; and
a controller connecting with the first connector, the second connector and the rewritable memory;
wherein if the first connector is connected to the first ROM socket and the motherboard is activated, the controller enters a first access mode to access the system code and passes the system code to the first ROM socket via the first connector for executing the system code; otherwise, if the second connector is connected to the second ROM socket and the motherboard is activated, the controller enters a second access mode to access the system code and passes the system code to the second ROM socket via the second connector for executing the system code.

2. The memory emulating apparatus as claimed in claim 1, wherein the first ROM socket is an industry standard architecture (ISA) socket, the second ROM socket is an low pin count (LPC) socket, and the rewritable memory is compatible with the first ROM socket; in the first access mode, the controller directly accesses the system code; in the second access mode, the controller performs a interface conversion process on control signals and system code signals transmitted between the second ROM socket and the rewritable memory to access the system code stored in the rewritable memory for executing the system code, wherein the controller serves as a LPC/ISA interface or an ISA/LPC interface.

3. The memory emulating apparatus as claimed in claim 1, wherein the controller is used to adjust a voltage level of signals transmitted between the rewritable memory and the first ROM socket or the second ROM socket and temporarily stores the signals.

4. The memory emulating apparatus as claimed in claim 1, wherein the motherboard further has a test port and the memory emulating apparatus further has a third connector for connecting with the test port; and if the third connector is connected to the test port and the motherboard is activated, the controller accesses the system code and passes the system code to the test port via the third connector for executing the system code.

5. The memory emulating apparatus as claimed in claim 4, wherein the test port is a LPC port, the rewritable memory is incompatible with the third connector, and the controller enters the second access mode to access the system code; in the second access mode, the controller performs a interface conversion process on control signals and system code signals transmitted between the test port and the rewritable memory to access the system code stored in the rewritable memory for executing the system code, wherein the controller serves as a LPC/ISA interface or an ISA/LPC interface.

6. The memory emulating apparatus as claimed in claim 1, further comprising a fourth connector, which is used to connect with a computer, wherein the system code is loaded into the rewritable memory via the fourth connector and the controller.

7. The memory emulating apparatus as claimed in claim 6, wherein the further comprising a connector control unit connecting with the fourth connector and the controller, wherein the connector control unit is used to control the fourth connector for data transmission with the controller so as to make the system code loaded into the rewritable memory via the controller.

8. The memory emulating apparatus as claimed in claim 7, wherein the fourth connector is a universal serial bus (USB) port and the connector control unit is a USB+8051 controller.

9. The memory emulating apparatus as claimed in claim 1, wherein the rewritable memory is an asynchronous static random access memory (ASYNC SRAM).

10. The memory emulating apparatus as claimed in claim 1, further comprising a displayer connecting with the controller, wherein the controller intercepts a test result and shows the test result on the displayer when the motherboard executes the system code and performs a Power On Self Test (POST) process.

11. The memory emulating apparatus as claimed in claim 10, wherein the controller intercepts a post/debug code from an input/output (I/O) port named 80h, decodes the post/debug code and shows the decoded post/debug code as the test result on the displayer.

12. The memory emulating apparatus as claimed in claim 10, wherein the controller intercepts a post/debug code from an I/O port named 84h, decodes the post/debug code and shows the decoded post/debug code as the test result on the displayer.

13. The memory emulating apparatus as claimed in claim 1, wherein the controller is an application specific integrated circuit (ASIC).

14. The memory emulating apparatus as claimed in claim 1, wherein the controller is a complex programmable logic device (CPLD).

15. A memory emulating method, applied for a memory emulating apparatus connecting with a motherboard, the motherboard having a first read-only memory (ROM) socket or a second ROM socket disposed thereon, the memory emulating method comprising:
providing a first connector for connecting with the first ROM socket;
providing a second connector for connecting with the second ROM socket; and
loading a system code into a rewritable memory of the memory emulating apparatus;
wherein if the first connector is connected to the first ROM socket and the motherboard is activated, the method further has a step of entering a first access mode to access the system code and passing the system code to the first ROM socket via the first connector for executing the system code; otherwise, if the second connector is connected to the second ROM socket and the motherboard is activated, the method further has a step of entering a second access mode to access the system code and passing the system code to the second ROM socket via the second connector for executing the system code.

16. The memory emulating method as claimed in claim 15, wherein the first ROM socket is an ISA socket, the second ROM socket is an LPC socket, and the rewritable memory is compatible with the first ROM socket; in the first access mode, the system code directly accessed; in the second access mode, a interface conversion process is performed on control signals and system code signals transmitted between the second ROM socket and the rewritable memory to access the system code stored in the rewritable memory for execution, wherein the interface conversion process serves to convert a LPC signal format to an ISA signal format or to convert the ISA signal format to the LPC signal format.

17. The memory emulating method as claimed in claim 15, wherein the motherboard further has a test port and the memory emulating method further has a step of providing a third connector for connecting with the test port; and if the third connector is connected to the test port and the motherboard is activated, the system code is accessed and passed to the test port via the third connector for execution.

18. The memory emulating method as claimed in claim 17, wherein the test port is a LPC port, the rewritable memory is incompatible with the test port, and the second access mode is entered to access the system code; in the second access mode, a interface conversion process is performed on control signals and system code signals transmitted between the test port and the rewritable memory to access the system code stored in the rewritable memory for execution, wherein the interface conversion process serves to convert a LPC signal format to an ISA signal format or to convert the ISA signal format to the LPC signal format.

19. The memory emulating method as claimed in claim 15, further comprising a step of providing a fourth connector, which is used to connect with a computer, wherein the system code is loaded into the rewritable memory via the fourth connector.

20. The memory emulating method as claimed in claim 19, wherein the fourth connector is a USB port.

21. The memory emulating method as claimed in claim 15, further comprising a step of providing a displayer, intercepting a test result and showing the test result on the displayer when the motherboard executes the system code and performs a Power On Self Test (POST) process.

22. The memory emulating method as claimed in claim 21, wherein the step of intercepting is performed by accessing a post/debug code from an I/O port named 80h, decoding the post/debug code and showing the decoded post/debug code as the test result on the displayer.

23. The memory emulating method as claimed in claim 10, wherein the step of intercepting is performed by accessing a post/debug code from an I/O port named 84h, decoding the post/debug code and showing the decoded post/debug code as the test result on the displayer.
